(19) United States
(12) Patent Application Publication
(10) Pub. No.: US 2019/0071528 A1
(43) Pub. Date: Mar. 7, 2019

(54) ALKOXYSILANE-FUNCTIONALIZED POLYACRYLATE COMPOSITIONS AND METHODS OF PREPARATION THEREOF

(71) Applicant: Henkel IP & Holding GmbH, Duesseldorf (DE)

(72) Inventors: Philip T. Klemarczyk, Canton, CT (US); David P. Dworak, Middletown, CT (US)

(21) Appl. No.: 16/182,768

(22) Filed: Nov. 7, 2018

Related U.S. Application Data
(62) Division of application No. 15/017,692, filed on Feb. 8, 2016.
Application No. 15/017,692 is a continuation of application No. PCT/US2014/045754, filed on Jul. 8, 2014.
(60) Provisional application No. 61/864,924, filed on Aug. 12, 2013.

(51) Int. Cl. C08F 220/18; C09J 143/04; C08F 8/14; C08K 5/57; C08K 5/544; C08K 5/5425; C08K 5/42; C08K 3/36; C09J 133/14; C08F 8/26; C08F 8/42; C08F 230/08

(52) U.S. Cl. CPC C08F 220/18; C08F 2810/40; C08F 8/14; C08K 5/57; C08K 5/544; C08K 5/5425; C08K 5/42; C08K 3/36; C09J 133/14; C08F 8/26; C08F 8/42; C08F 230/08; C08F 2220/1825; C08F 2438/01; C08F 2800/10; C08F 2810/30; C09J 143/04

(57) ABSTRACT

A process for preparing moisture curable compounds and moisture curable compositions prepared from the product of that process is provided.

### BACKGROUND

### Field

A process for preparing moisture curable compounds and moisture curable compositions prepared from the product of that process is provided.

### Brief Description of Related Technology

Moisture curable monomers, oligomers and polymers, and compositions made therewith, are well-known and have been described extensively and used commercially for some time.

One such polymer is an alkoxysilane terminated polyacrylate. Commercially available moisture curable, alkoxysilane terminated polyacrylates (such as those available from Kaneka Corporation, Japan) are currently prepared in a two step process. See also U.S. Pat. Nos. 5,986,014, 6,274,688, and 6,420,492. In a disclosed process, bromine substitution with an unsaturated carboxylic acid is followed by hydrosilation with an alkoxysilane. This two step process can be expensive and time consuming for the manufacturer. In addition, the additional step increases operator handling, which may lead to a less pure product by for instance a greater chance of cross linking or the introduction of impurities. In the latter instance, further steps may be required in order to purify the product. An idealized form of the synthesis is shown in FIG. 1.

It would be desirable to identify alternative synthetic schemes by which to make such polymers for a variety of reasons, including raw material reactant availability and reducing the complexity of the synthesis. For instance, reducing the number of synthetic steps can save on labor and time or processing, thereby creating a more efficient way in which to obtain these, and other, polymers.

### SUMMARY

The present invention provides such a solution to that desire.

In one aspect a process for preparing alkoxysilane-functionalized hydrocarbon compounds is provided. The process includes providing (a)

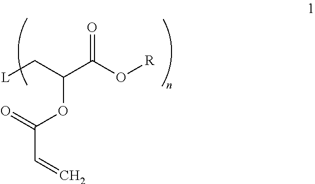

where L is alkyl or poly(alkyl), alkylene or poly(alkylene), alkenyl or poly(alkenyl), alkenylene or poly(alkenylene), aromatic or an aromatic ring system, R is alkyl, and n is 1-4, and (b) an aminoalkylalkoxysilane, and optionally (c) organic solvent, in a vessel and mixing for a time sufficient to form an alkoxysilane-functionalized hydrocarbon compound.

The present invention will be more fully appreciated by a reading of the “Detailed Description”, and the illustrative examples which follow thereafter.

### BRIEF DESCRIPTION OF THE FIGURES

FIG. 1 shows an idealized form of a two step process used to prepare on a commercial scale moisture curable, alkoxysilane terminated polyacrylates, where a bromine substituted polymer is reacted with an unsaturated carboxylic acid followed by hydrosilation with an alkoxysilane.

FIG. 2 shows a reaction between APTES and an acrylate-terminated polymer. As shown, the polymer was treated with an excess of APTES in ethyl acetate at ambient temperature to give the desired product. (See also Example 1.)

FIG. 3 shows GPC analysis of a 27,000 MW terpolymer (butyl acrylate/ethyl acrylate/acrylonitrile) and the 27,000 MW terpolymer/APTES capped product, as presented in Table A.

FIG. 4 shows GPC analysis of RC100 and RC100/APTES capped polymer product, as presented in Table A.

FIG. 5 shows GPC analysis of a 30,000 MW terpolymer and the 30,000 MW terpolymer/APTES capped product, as presented in Table A.

FIG. 6 shows Rheometric analysis in terms of complex shear modulus over time of a formulation made with the RC100/APTES capped polymer (Sample No. 1) and one made with the OR110S control (Sample No. 4), as presented in Table 1.

FIG. 7 shows Rheometric analysis in terms of complex shear modulus over time of a formulation made with the 27,000 MW terpolymer/APTES capped polymer (Sample No. 2) and one made with the OR110S control (Sample No. 4), as presented in Table 1.

FIG. 8 shows Rheometric analysis in terms of complex shear modulus over time of a formulation made with the 30,000 MW terpolymer/APTES capped polymer (Sample No. 3) and one made with the OR110S control (Sample No. 4), as presented in Table 1.

FIG. 9 shows Rheometric analysis in terms of complex shear modulus over time of a formulation made with the RC100/APTMS capped polymer (Sample No. 5) and one made with the OR110S control (Sample No. 4), as presented in Table 2.

FIG. 10 shows Rheometric analysis in terms of complex shear modulus over time of a formulation made with the 30,000 MW terpolymer/APTMS capped polymer (Sample No. 6) and one made with the OR110S control (Sample No. 4), as presented in Table 2.

FIG. 11 shows a Rheometric analysis of 30,000 MW terpolymer/BESA capped polymer (Sample No. 7) and one made with the OR110S control (Sample No. 4), as presented in Table 2.

FIG. 12 shows tensile strength of a series of moisture curable formulations (Sample Nos. 4, 5, 1, 6 and 2, respectively) on assemblies of lapshears made from steel, aluminum or one of each.

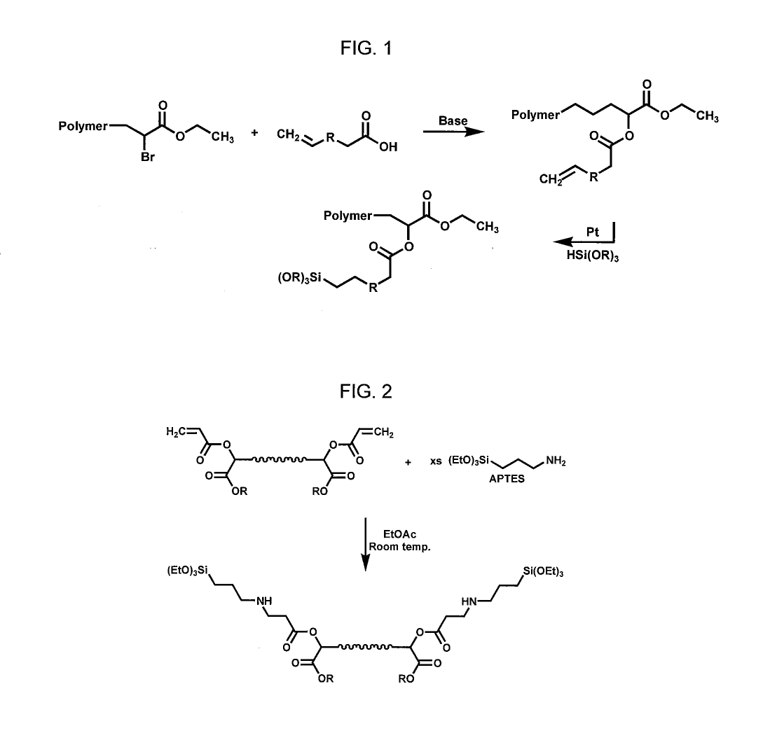

### DETAILED DESCRIPTION

The present invention provides in one aspect a process for preparing an alkoxysilane-functionalized hydrocarbon compound made from (a)

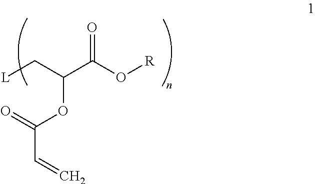

where L is alkyl or poly(alkyl), alkylene or poly(alkylene), alkenyl or poly(alkenyl), alkenylene or poly(alkenylene), aromatic or an aromatic ring system, R is alkyl, such as from 1 to 10 carbon atoms, optionally interrupted by one or more oxygen atoms, and n is 1-4, and (b) an aminoalkylalkoxysilane, and optionally (c) organic solvent in a vessel, and mixing for a time sufficient to form an alkoxysilane-functionalized hydrocarbon compound.

L, or linker or linking groups, may be selected from alkyl or poly(alkyl), alkylene or poly(alkylene), alkenyl or poly(alkenyl), alkenylene or poly(alkenylene), aromatic or an aromatic ring system. The alkyl linker, when n is 1, may be an aliphatic group of 1 to 20 carbon atoms. The alkyl linker may be straight chain, branched chain or contain or be made from one or more cycloaliphatic group(s). The alkenyl linker, when n is 1, may be an unsaturated aliphatic group of 2 to 20 carbon atoms. The alkenyl linker may be straight chain, branched chain or contain or be made from one or more cycloaliphatic group(s). The aromatic linker, when n is 1, may have 6 to 20 carbon atoms.

When n is 2-4, the alkylene linker may be straight chain, branched chain or contain or be made from one or more cycloaliphatic group(s) of 1 to 20 carbon atoms, as appropriate; the alkenylene linker may be straight chain, branched chain or contain or be made from one or more cycloaliphatic group(s) of 2 to 20 carbon atoms, as appropriate. The aromatic linker may have from 6 to 20 carbon atoms.

The polymer versions of the alkyl, alkylene, alkenyl and alkenylene groups are defined similarly, except that each is made up of repeating residues in a block, graft or random order. The polymer versions are ordinarily defined by their molecular weights, which here are between about 1,000 Mn and about 500,000 Mn, and which may be tailored appropriately to the end use commercial for which they are destined. A particularly desirable polymer version is a poly(acrylate) made from one or more (meth)acrylate or acylonitrile monomers.

R may be selected from an alkyl group, as noted above, which may be from 1 to 10 carbon atoms, optionally interrupted by one or more oxygen atoms. Particularly desirable R groups are ethyl, propyl, butyl and hexyl, and methoxy ethyl.

The compound shown in structure 1 may have a central polyacrylate segment [where if made by a controlled radical polymerization (“CRP”) technique will have such a segment about a central initiator segment]. The initiator may be any of a variety of materials provided the initiator has one or more displacable halogens. See e.g. U.S. Pat. No. 5,763,548. One desirable initiator, and the one used to make the polymers in the examples is

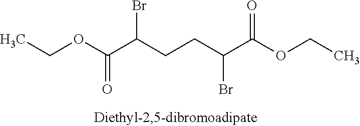 [SMILES: CCOC(=O)C(Br)CCC(Br)C(=O)OCC]

An example of the compound shown in structure 1 is an acrylate terminated polybutyl acrylate, like

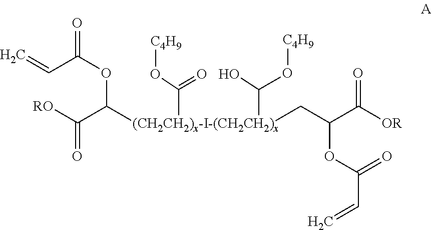

where I is an organic compound having one or more displacable halogens and R is C₄H₉ and x is 78 so that the compound has a molecular weight of about 20,000;
the acrylate terminated butyl acrylate-ethyl acrylate-methoxyethyl acrylate terpolymer shown below:

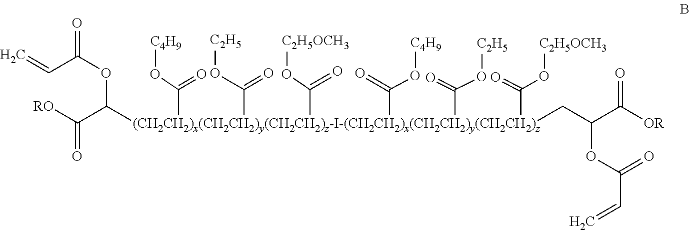

where I and R are as defined above, x is 92, y is 25 and z is 6, so that the terpolymer has a molecular weight of about 30,000 Mn;
or
the acrylate terminated butyl acrylate-ethyl acrylate-acrylonitrile terpolymer shown below:

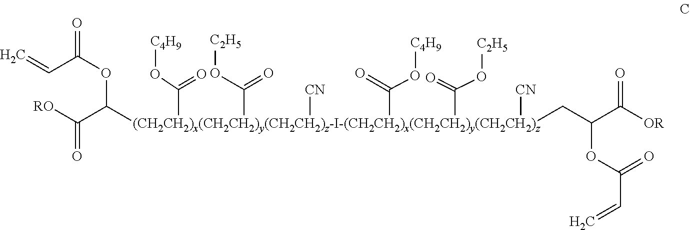

where I and R are as defined above, x is 82, y is 22 and z is 6, so that the terpolymer has a molecular weight of about 27,000 Mn.

The compound shown in structure 1 may have a central polyoctyl segment (where if made by a CRP technique will have such a segment about a central initiator segment), such as an acrylate terminated polyoctyl acrylate, like

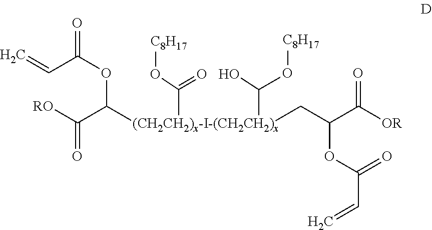

where I is as defined above, R is C₈H₁₇ and x is 55 so that the compound has a molecular weight of about 20,000 Mn.

In one embodiment, the compound shown in structure 1 is a di-(2-carboxylic acid alkanoate, polyacrylate). See Example 3 infra for a representative structure thereof. Here, the di-(2-carboxylic acid alkanoate, polyacrylate) should have a molecular weight in the range of about 1,000 Mn to about 50,000 Mn, such as about 30,000 Mn.

The aminoalkylalkoxysilane may be chosen from a host of possible choices. For instance, the amino alkyl portion of the alkoxy silane may have as the alkyl (or alkylene) residue a variety of linkages including methyl, ethyl, propyls, butyls, pentyls and hexyls, to name a few. The alkoxy portion of the alkoxysilane may be present once, twice or three times on the silicon atom of the silane and may be chosen from a variety of groups including methoxy, ethoxy, and propoxy.

A generic structure of the aminoalkylalkoxysilane may be seen below

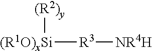

where R¹ and R² are selected from alkyl groups having from 1 to 4 carbon atoms, R³ is selected from alkylene and arylene residues and R⁴ is selected from hydrogen and alkyl groups having from 1 to 4 carbon atoms, and when x is 3, y is 0 and when x is 2, y is 1. Alternatively, R⁴ may include an aminoalkylalkoxysilane itself (that satisfies the definitions provided above).

Examples of the aminoalkylalkoxysilanes include aminopropyltriethoxysilane (“APTES”), aminopropyltrimethoxysilane (“APTMS”), N-methylaminopropyltrimethoxysilance (“MAPTMS”), N-methylaminopropyltriethoxysilance (“MAPTES”), bis(triethoxysilylpropyl)amine (“BESA”) and aminopropyldiethoxymethylsilane (“APDEMS”).

The aminoalkylalkoxysilane should be used in a molar excess to the compound shown in structure 1. For instance, a 2 to 10 molar excess, such as 4 to 8 molar excess, is desirable.

Optionally, the process may be conducted in an appropriate organic solvent, which is aprotic. Desirably, when used, the organic solvent is an alkyl acetate, such as ethyl acetate, or acetonitrile.

In practicing the process, mixing occurs (with or without solvent) at ambient temperature desirably for a period of time of about 2 to about 48 hours to achieve a yield of greater than about 90% of the alkoxysilane-functionalized hydrocarbon compound.

The process for preparing the alkoxysilane-functionalized hydrocarbon compounds from

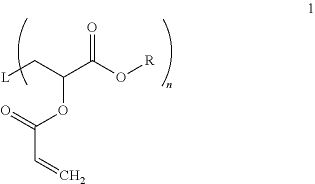

where L is alkyl or poly(alkyl), alkylene or poly(alkylene), alkenyl or poly(alkenyl), alkenylene or poly(alkenylene), aromatic or an aromatic ring system, R is alkyl, and n is 1-4 may employ a compound having a polymeric, oligomeric or elastomeric central portion for L, as noted above. In such a situation, it may be particlarly useful to employ a CRP technique, which is capable of introducing a given functional group into a defined position on the polymer, such as at the terminus. CRP is advantageous because of the low velocity polymerization and low tendency of termination by radical-radical coupling, a termination reaction does not easily take place, thus giving a polymer with a narrow molecular weight distribution (Mn/Mn=about 1.1 to 1.5), and because the molecular weight can be freely controlled by adjusting the monomer/initiator charge ratio.

A variety of CRP techniques may be used to make compounds within structure 1 including but not limited to atom transfer radical polymerization (“ATRP”), single electron transfer living radical polymerization (“SET-LRP”)”, and reversible addition fragment transfer (“RAFT”), to name a few. In ATRP a vinyl monomer is polymerized using an organohalogen compound or a sulfonyl halide compound as the initiator and a transition metal complex as the catalyst. In the CRP methods, which are particularly attractive in the context of the present invention, in addition to the noted advantages, a polymer having a halogen atom at its terminus may be formed. A halogen atom in that position on the polymer is particularly interesting because of the ease with which it may be displaced to form a (meth)acrylate functional group.

In another aspect the product made by the inventive process may be formulated with a curable matrix. Desirably, the curable matrix comprises a moisture curable silicone, such as one bearing alkoxy functionality.

The moisture curable composition, whether formulated with a curable matrix or simply based on the aminoalkylalkoxysilane-functionalized hydrocarbon compounds made by the processes disclosed herein, should also include a moisture cure catalyst.

The moisture cure catalysts include tin IV salts of carboxylic acids, such as dibutyltin dilaurate, organotitanium compounds such as tetrabutyl titanate, and partially chelated derivatives of these salts with chelating agents such as acethyl acetateetic acid esters and beta-diketones and amines. Desirably, tetraisopropyltitanate, dibutyltin dilaurate and tetramethylguandine at levels of about 0.05 to about 0.5% are used.

Other additives such as thickeners, non-reactive plasticizers, fillers, toughening agents (such as elastomers and rubbers) and other well-known additives may be incorporated therein where the art-skilled believes it would be desirable to do so. In addition, cross linking agents may also be incorporated therein, examples of which being substituted trialkoxysilanes, such as APTMS, APTES, APDEMS and vinyl trimethoxysilane.

The invention also provides a process for preparing a reaction product from the moisture curable composition, the steps of which include applying the composition to a desired substrate surface and exposing the composition to appropriate conditions for a time sufficient to cure the composition.

In view of the above description, it is clear that a wide range of practical opportunities is provided. The following examples are provided for illustrative purposes only, and are not to be construed so as to limit in any way the teaching herein.

### EXAMPLES

Rheometric analysis was done on a TA Instruments AR2000EX Rheometer with 8 mm diameter parallel plates at a gap of 1.0 mm. Solventless mixing was performed with the use of a FlackTec Speedmixer. Anhydrous ethyl acetate, APTMS, APTES, MAPTMS, and BMSA were purchased from the Sigma-Aldrich Chemical Co. and were used without further purification. BESA was purchased from Gelest Corporation and was used without further purification. XMAP OR110S, a methyldimethoxysilyl terminated polyacrylate, and XMAP RC100, an acrylate terminated polyacrylate, were purchased from Kaneka Corporation and used without further purification.

### A. Synthesis

### Example 1

To a 250 mL one-neck round bottom flask, equipped with a stir bar, magnetic stirrer, and a nitrogen inlet, was added a 27,000 MW acrylate-terminated butyl acrylate/ethyl acrylate/acrylonitrile (70/20/10) terpolymer (27 g, 1 mol), which had been prepared by controlled radical polymerization and, in a subsequent reaction, transformed into a diacrylate. To the terpolymer was added aminopropyltriethoxysilane (1.9 g, 8.8 mmol) and ethyl acetate (100 mL) under nitrogen, and the reaction proceeded along the lines shown in the reaction scheme in FIG. 2. The solution was stirred overnight at ambient temperature, after which time, solvent was removed under reduced pressure, and the product was vacuum dried. Yield=28.99 g (Quantitative).

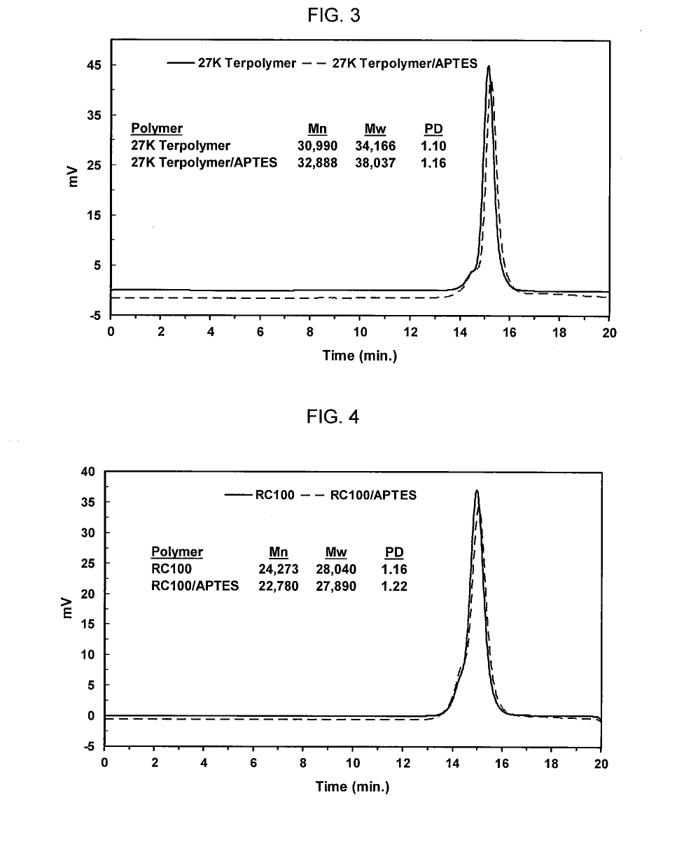

The resulting product was analyzed by gel phase chromatography (“GPC”) to determine molecular weight and polydispersity, and the GPC curves of the starting material and product, along with the GPC data, are shown in FIG. 3.

### Example 2

To a 2 oz. polypropylene Speedmixer cup was added a 30,000 MW terpolymer (15 g) and aminopropyltriethoxysilane (0.9 g). The cup was tightly capped, and placed into the Speedmixer. The two components were blended for three minutes at 3,000 rpm. The mixture was then allowed to age overnight at ambient temperature. Proton NMR analysis showed the reaction to be complete, because of the absence of peaks, which correspond to the protons on the acrylate double bond. Yield=15.9 g (Quantitative).

### Example 3

The following aminoalkylalkoxysilane-functionalized hydrocarbon compounds were prepared along the lines of the methods described herein, where R and R′ are as shown:

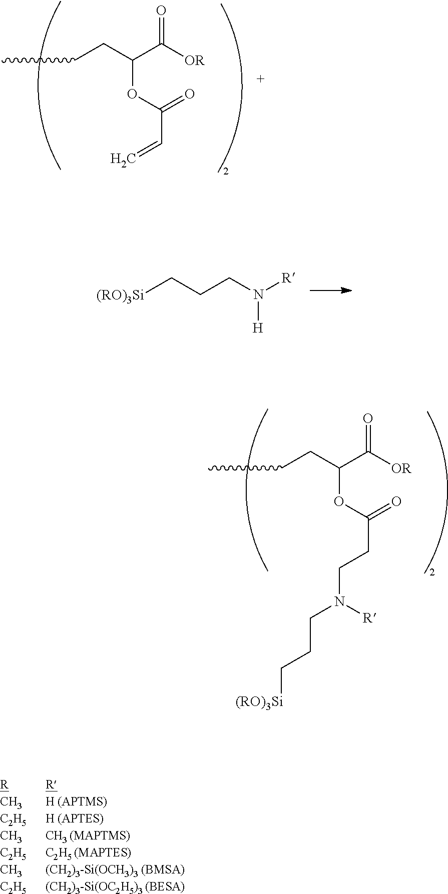

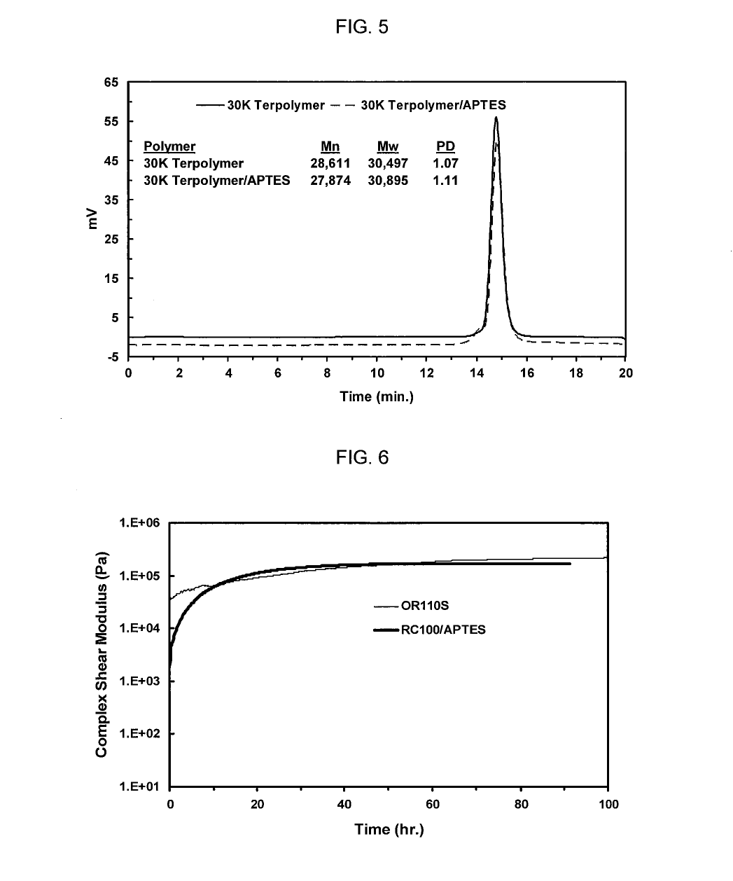

The resulting polymers were analyzed by gel phase chromatography (“GPC”) to determine their molecular weights and polydispersity. The GPC curves of the starting material and APTES capped products are shown in FIGS. 3-5. The starting polymers and their compositions are given in Table A below, along with a control, XMAP RC100, which is commercially available from Kaneka Corporation, Japan.

TABLE A

| Polymer | Composition |
|---|---|
| XMAP RC100 | Acrylate terminated polyacrylate (control) |
| 27K Terpolymer | 27,000 MW Butyl acrylate-ethyl acrylate-acrylonitrile terpolymer (70-20-10 mole ratio) |
| 30K Terpolymer | 30,000 MW Butyl acrylate-ethyl acrylate-methoxyethyl acrylate terpolymer (75-20-5 mole ratio) |

Use of the process described here allows for reaction to occur at room temperature, which is an equipment and an energy savings, and optionally without solvent, which is a raw material, equipment and process savings.

Because of the large number of commercially available aminoalkylalkoxysilanes, the process so described provides great flexibility for modifying the underlying polymer and the properties desired. And because aminoalkylalkoxysilanes are generally high boiling liquids, the process so described may be carried out in ordinary reactors, which is another savings for equipment, laboratory and production plant blue print, and process time.

### B. Moisture Curable Adhesive Formulation

The product in Example 2 above (termed in the table, “Moisture Curable Polyacrylate”), MESAMOLL-brand plasticizer, and CAB-O-SIL TS530-brand silica were added to a mixing cup and blended in a DAC 150 speedmixer. The two crosslinkers and the catalyst were then added, and the formulations mixed for a second time (both times for 3 minutes at 2750 rpm). Sample Nos. 1-3 were thus formed. A control sample (shown in Tables 1 and 2 as Sample No. 4) was also formed in this fashion, though instead of the product of Example 2, KANEKA OR110S-brand polyacrylate was used in the same amount. The identities and relative amounts of the various constiuents are shown below in Table 1 (Formulations for APTES Capped Polymers). Table 2 shows Sample Nos. 5-7, in which APTMS or BESA were used to cap the polymer, where the APTMS or BESA capped polymer was used in the same amount as the APTES capped polymer.

TABLE 1

| Resin | Description | 1 (wt. %) | 2 (wt. %) | 3 (wt. %) | 4 (wt. %) |
|---|---|---|---|---|---|
| RC100/APTES | Moisture cure polyacrylate | 83.66 | — | — | — |
| 27K Terpolymer/APTES | Moisture cure polyacrylate | — | 83.66 | — | — |
| 30K Terpolymer/APTES | Moisture cure polyacrylate | — | — | 83.66 | — |
| Kaneka OR110S | Commercial resin control | — | — | — | 83.66 |
| Mesamoll | Plasticizer | 6.33 | 6.33 | 6.33 | 6.33 |
| Cab-O-Sil TS530 | Filler | 4.19 | 4.19 | 4.19 | 4.19 |
| Vinyltrimethoxysilane | Crosslinker | 1.66 | 1.66 | 1.66 | 1.66 |
| APTMS | Crosslinker | 2.08 | 2.08 | 2.08 | 2.08 |
| Dibutyltin dilaurate | Catalyst | 2.08 | 2.08 | 2.08 | 2.08 |

APTES = aminopropyltriethoxysilane
APTMS = aminopropyltrimethoxysilane
RC100/APTES = Kaneka RC100/APTES product
27K Terpolymer/APTES = 27,000 MW Butyl acrylate-ethyl acrylate-acrylonitrile terpolymer (70-20-10 mole ratio)/APTES
30K Terpolymer/APTES = 30,000 MW Butyl acrylate-ethyl acrylate-methoxyethyl acrylate terpolymer (75-20-5 mole ratio)/APTES

TABLE 2

| Resin | Description | 5 (wt. %) | 6 (wt. %) | 7 (wt. %) | 4 (wt. %) |
|---|---|---|---|---|---|
| RC100/APTMS | Moisture cure polyacrylate | 83.66 | — | — | — |
| 30K Terpolymer/APTMS | Moisture cure polyacrylate | — | 83.66 | — | — |
| 30K Terpolymer/BESA | Moisture cure polyacrylate | — | — | 83.66 | — |
| Kaneka OR110S | Commercial resin control | — | — | — | 83.66 |
| Mesamoll | Plasticizer | 6.33 | 6.33 | 6.33 | 6.33 |
| Cab-O-Sil TS530 | Filler | 4.19 | 4.19 | 4.19 | 4.19 |
| Vinyltrimethoxysilane | Crosslinker | 1.66 | 1.66 | 1.66 | 1.66 |
| APTMS | Crosslinker | 2.08 | 2.08 | 2.08 | 2.08 |
| Dibutyltin dilaurate | Catalyst | 2.08 | 2.08 | 2.08 | 2.08 |

APTMS = aminopropyltrimethoxysilane
BESA = Bis(triethoxysilylpropyl)amine
RC100/APTMS = Kaneka RC100/APTMS product
30K Terpolymer/APTMS = 30,000 MW Butyl acrylate-ethyl acrylate-methoxyethyl acrylate terpolymer (75-20-5 mole ratio)/APTMS

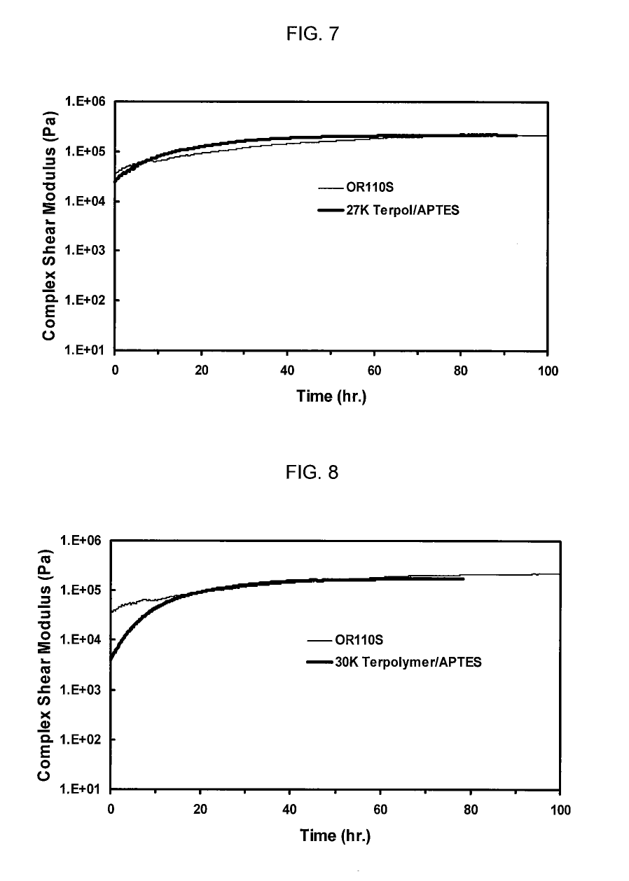

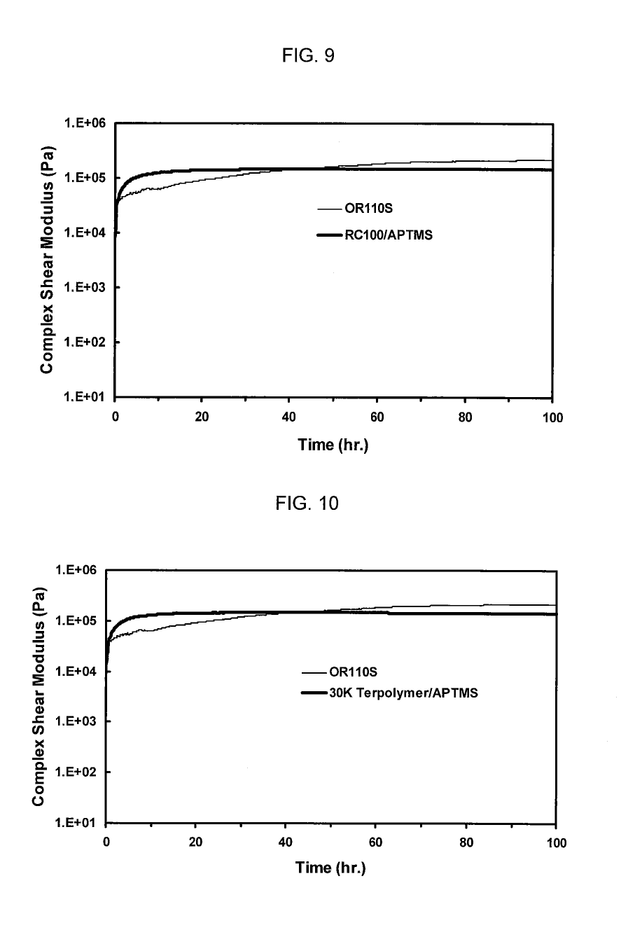

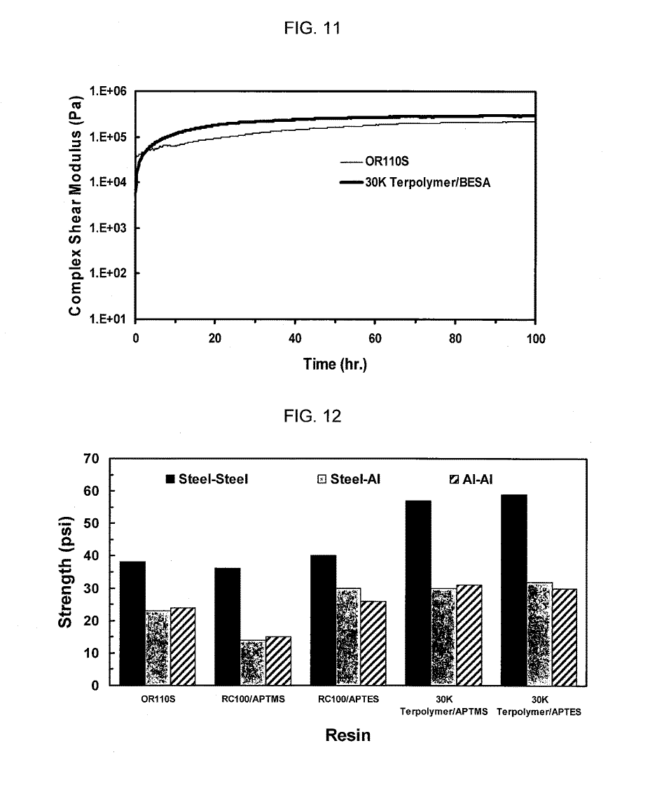

The samples were loaded onto the rheometer with 8 mm diameter parallel plates at a gap of 1.0 mm. For the oscillatory rheometer experiment, strain was set at 0.04% with a minimum torque specification of 30 microN*m. Frequency was set to 30 rad/s. One data point was collected every ten minutes over a total experiment run time of six or seven days. Complex shear modulus was plotted as a function of time to determine relative cure speed and degree of ultimate cure for the different moisture cure formulations. Reference to FIGS. 6-11 shows these results.

As-received mild steel and aluminum lapshears were cleaned by immersion in acetone and wiped dry. The experimental adhesive was applied to one lapshear. The second lapshear was pressed against it by hand with a half-inch overlap, and the specimen was placed into a Teflon jig, which was designed to create a 20 mil gap between the two lapshears. Five steel-steel, steel-aluminum, and aluminum-aluminum lapshear test specimens were assembled for each adhesive formulation. The specimens were aged for one week at ambient temperature in a room with controlled 50% humidity. They were then tested in an Instron Tensile Tester according to ASTM D-1002. The adhesive strength was obtained from the average of the tensile strength measurements of the five test specimens. Table 3 shows the results of this evaluation, and FIG. 12 captures those results graphically in a bar chart.

TABLE 3

| | Adhesive Strength (psi) | | |
|---|---|---|---|
| Resin | Steel-Steel | Steel-Al | Al—Al |
| OR110S | 38 | 23 | 24 |
| RC100/APTMS | 36 | 14 | 15 |
| RC100/APTES | 40 | 30 | 26 |
| 30K Terpolymer/APTMS | 57 | 30 | 31 |
| 30K Terpolymer/APTES | 59 | 32 | 30 |

The samples containing the APTES, APTMS and BESA capped polymers provide a modulus upon moisture cure that is essentially that of the control sample.

1. A process for preparing aminoalkylalkoxysilane-functionalized hydrocarbon compounds, comprising:
providing (a) 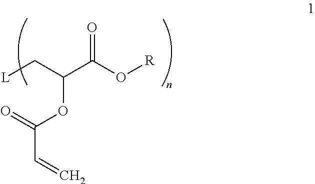
wherein L is a polymer having a molecular weight between about 1,000 Mn and 500,000 Mn, each R is independently alkyl optionally interrupted by one or more O atoms, and n is 2-4,
(b) an aminoalkylalkoxysilane, and
(c) organic solvent in a vessel and
mixing (a)-(c) for a time sufficient to form an aminoalkylalkoxysilane-functionalized hydrocarbon compound.

2. The process of claim 1, wherein the organic solvent is ethyl acetate.

3. The process of claim 1, wherein mixing occurs at room temperature.

4. The process of claim 1, wherein mixing at room temperature occurs for a period of time of about 2 to about 24 hours.

5. The process of claim 1, wherein mixing at room temperature occurs for a period of time of about 2 to about 24 hours to achieve a yield of greater than about 90% of the aminoalkyl alkoxysilane-functionalized hydrocarbon compound.

6. The process of claim 1, wherein the compound shown in structure 1 was made by a controlled radical polymerization technique.

7. An aminoalkyl alkoxysilane-functionalized hydrocarbon compound made in accordance with the process of claim 1.

8. A moisture curable composition, comprising:
(a) an aminoalkyl alkoxysilane-functionalized hydrocarbon compound made in accordance with the process of claim 1; and
(b) a moisture cure catalyst.

9. The composition of claim 8, further comprising one or more of a filler component, a toughening component, a plasticizer component and a cross linker component.

10. Cured reaction products of the composition of claim 8.

11. The process of claim 1, wherein polymer L comprises acrylate segments.

12. The process of claim 1, wherein polymer L comprises different acrylate segments.

13. The process of claim 1, wherein polymer L comprises acrylate segments and acrylonitrile segments.

14. The process of claim 1, wherein polymer L comprises a plurality of pendant —C(O)—O—C₁₋₈ moieties.

15. The process of claim 1, wherein polymer L comprises at least two —CH2-CH—C(O)—O—C₁₋₈ segments and an organic moiety having one or more displaceable halogens connecting two of the segments.

16. The process of claim 1, wherein aminoalkylalkoxysilane (b) has the structure 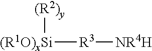
where R¹ and R² are selected from alkyl groups having from 1 to 4 carbon atoms, R³ is selected from alkylene and arylene residues and R⁴ is selected from hydrogen and alkyl groups having from 1 to 4 carbon atoms, and when x is 3, y is 0 and when x is 2, y is 1.

17. The process of claim 1, wherein aminoalkylalkoxysilane (b) is selected from the group consisting of aminopropyltriethoxysilane (“APTES”), aminopropyltrimethoxysilane (“APTMS”), N-methylaminopropyltrimethoxysilance (“MAPTMS”), N-methylaminopropyltriethoxysilance (“MAPTES”), bis(triethoxysilylpropyl)amine (“BESA”) and aminopropyldiethoxymethylsilane (“APDEMS”).

18. The process of claim 1, wherein aminoalkylalkoxysilane (b) is provided in a 2 to 10 molar excess to compound (a).

19. The process of claim 1, wherein n=2.

20. The process of claim 1, wherein polymer L is a terpolymer.
